(19) United States
(12) Patent Application Publication
(10) Pub. No.: US 2024/0021329 A1
(43) Pub. Date: Jan. 18, 2024

(54) APPARATUS AND METHODS FOR GRAPPLING INSTRUMENTS

(71) Applicants: William F. Bianco, Pottsown, PA (US); Cory Ogden, Frederick, MD (US)

(72) Inventors: William F. Bianco, Pottsown, PA (US); Cory Ogden, Frederick, MD (US)

(21) Appl. No.: 18/037,156

(22) PCT Filed: Nov. 16, 2021
(86) PCT No.: PCT/US2021/059501

§ 371 Date: May 16, 2023

Related U.S. Application Data
(60) Provisional application No. 63/114,175, filed on Nov. 16, 2020.

(51) Int. Cl. G21C 19/02

(52) U.S. Cl. CPC G21C 19/02

(57) ABSTRACT

An apparatus, such as a grapple device, may include a mounting plate that includes a top end and a bottom end. The grapple device may include a first fork coupled near the top end of the mounting plate and a second fork coupled near the bottom end. The first fork may include a first elongated member and a second elongated member and the second fork may include a third elongated member and a fourth elongated member. The first elongated member may be longer than the second elongated member. The grapple device may also include a lifting member coupled to the mounting plate and a lifting ring configured to move along the lifting member. The grapple device may also include a locking plate that includes an aperture. The grapple device may also include a cylinder and a locking pin coupled to the cylinder and configured to engage the aperture.

### CROSS-REFERENCE TO RELATED PATENT APPLICATION

This application claims the benefit of and priority to U.S. Provisional Patent Application No. 63/114,175, filed Nov. 16, 2020, the entire contents of which are hereby incorporated herein by reference in its entirety.

### BACKGROUND

Instruments, such as nuclear instruments, may be used in the generation of nuclear power. For example, the instruments may be used in the generation of power in a boiling water reactor (BWR) or another type of nuclear reactor. Over time, spent, or used, nuclear instruments need to be removed from a reactor pool. Prior to moving the instrument from the reactor pool, the instrument may be cut or separated into an irradiated portion and a portion that is irradiated only at one end where it was cut or separated from the irradiated portion. A top portion of the instrument (e.g., the irradiated portion) may be held by a first device and a bottom portion of the instrument (e.g., the portion irradiated at one end only) may be held by a second device. After severing, the portion that is irradiated only at one end needs to be moved from the reactor pool to a spent fuel pool. The transition of the portion of the instrument to the spent fuel pool may include inverting the portion of the instrument to assure sufficient radiation shielding, provided by the water in the pool, of the irradiated end. It can be difficult for a device to securely grasp the portion of the instrument, invert it, and move it from the reactor pool to the spent fuel pool.

### SUMMARY

It is to be understood that both the following general description and the following detailed description are exemplary and explanatory only and are not restrictive. A grapple device apparatus and method for using the grapple device are described.

In one example, an apparatus may include a mounting plate. The apparatus may further include a fork coupled to the mounting plate. The fork may include a first elongated member and a second elongated member. The apparatus may further include a lifting member coupled to the mounting plate. The apparatus may further include a lifting ring. The lifting ring may be movably engaged with the lifting member.

In another example, an apparatus may include a mounting plate. The mounting plate may include a top end and a bottom end. The apparatus may further include a first fork. The first fork may be coupled to the mounting plate adjacent to the top end of the mounting plate. The apparatus may further include a second fork coupled to the mounting plate.

In another example, an apparatus may include a mounting plate. The apparatus may further include a fork coupled to the mounting plate. The fork may include a first elongated member and a second elongated member. The apparatus may further include a plate member coupled to the mounting plate. The plate member may include an aperture that extends through at least a portion of the plate member. The apparatus may further include a cylinder. The cylinder may include a cylinder rod. The cylinder rod may be configured to move from a first position to a second position. The apparatus may further include a locking pin. The locking pin may be coupled to a free end of the cylinder rod. The locking pin may be configured to engage the aperture in the plate member when the cylinder rod is in the second position and disengage from the aperture when the cylinder rod is in the first position.

This summary is not intended to identify critical or essential features of the disclosure, but merely to summarize certain features and variations thereof. Other details and features will be described in the sections that follow.

### BRIEF DESCRIPTION OF THE DRAWINGS

For a more complete understanding of the present disclosure and certain features thereof, reference is now made to the following description, in conjunction with the accompanying figures briefly described as follows.

FIG. 1A is a front perspective view of a grapple device in accordance with an example embodiment of the disclosure;

FIG. 1B is a side elevation view of the grapple device of Figure TA in accordance with the example embodiment of the disclosure;

FIG. 1C is another front perspective view of the grapple device of Figure TA in accordance with the example embodiment of the disclosure;

FIG. 2A is a front perspective view of another grapple device in accordance with another example embodiment of the disclosure;

FIG. 2B is a front elevation view of the grapple device of FIG. 2A in accordance with the other example embodiment of the disclosure;

FIG. 3 is side elevation view of a grapple device showing another example lifting bail in accordance with another example embodiment of the disclosure;

FIG. 4A is a front perspective view of another grapple device in accordance with another example embodiment of the disclosure;

FIG. 4B is a rear perspective view of the grapple device of FIG. 4A in accordance with the other example embodiment of the disclosure; and

FIG. 4C is a top plan view of the grapple device of FIG. 4A in accordance with the other example embodiment of the disclosure.

### DESCRIPTION OF EXAMPLE EMBODIMENTS

As used in the specification and the appended claims, the singular forms “a,” “an,” and “the” include plural referents unless the context clearly dictates otherwise. Ranges may be expressed herein as from “about” or “substantially” one particular value, and/or to “about” or “substantially” another particular value. When such a range is expressed, another configuration includes from the one particular value and/or to the other particular value. When values are expressed as approximations, by use of the antecedent “about” or “substantially” it will be understood that the particular value forms another configuration. It will be further understood that the endpoints of each of the ranges are significant both in relation to the other endpoint, and independently of the other endpoint.

“Optional” or “optionally” means that the subsequently described element, feature, event, or circumstance may or may not be included or occur, and that the description includes cases where said element, feature, event, or circumstance is included or occurs and cases where it is not included or does not occur.

Throughout the description and claims of this specification, the word “comprise” and variations of the word, such as “comprising” and “comprises,” means “including but not limited to,” and is not intended to exclude other components, integers or steps. “Such as” is not used in a restrictive sense, but for explanatory purposes.

Certain relationships between dimensions of the device described herein and between features of the device are described herein using the term “substantially.” As used herein, the terms “substantially” and “substantially equal” indicates that the equal relationship is not a strict relationship and does not exclude functionally similar variations therefrom. Unless context or the description indicates otherwise, the use of the term “substantially” or “substantially equal” in connection with two or more described dimensions or positions indicates that the equal relationship between the dimensions or positions includes variations that, using mathematical and industrial principles accepted in the art (e.g., rounding, measurement or other systematic errors, manufacturing tolerances, etc.), would not vary the least significant digit of the dimensions. As used herein, the term “substantially parallel” indicates that the parallel relationship is not a strict relationship and does not exclude functionally similar variations therefrom. As used herein the term “substantially orthogonal” indicates that the orthogonal or perpendicular relationship is not a strict relationship and does not exclude functionally similar variations therefrom.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, elements and features in described apparatuses and steps in described methods. Thus, if there are a variety of additional steps that may be performed or elements and features that may be included or substituted, it is understood that each of these additional steps may be performed or elements and features may be included or substituted with any specific configuration or combination of configurations of the described methods, systems, and apparatuses.

A grapple device is a tool or device for grabbing or gripping an object. In some examples, the grapple device may be used to grab elongated members (e.g., nuclear instruments) and may be used to support movement of the elongated members from one location to another. For example, the grapple device may be used to grab and move any type of nuclear instrument from any type of reactor. For example, the grapple device may be used to grab and move nuclear instruments from a boiling water reactor (BWR). The nuclear instruments may be spent nuclear instruments. For example, the nuclear instruments may be local power range monitors (LPRMs), wide range neutron monitor (WRNM) dry tubes, source range monitor (SRM) dry tubes, intermediate range monitor (IRM) dry tubes or universal dry tubes.

The grapple device may engage the lower end of a spent nuclear instrument under the surface of the water so that following the severing of the instrument into 2 pieces, a portion of the instrument may be inverted and manually raised so that a first portion of the portion of the instrument is above the surface of the water and a second portion (e.g., the irradiated end portion) of the portion of the instrument remains under the surface of the water, to support movement of the portion of the instrument to a spent fuel pool (or other selected location) for storage. For example, the portion of the instrument grappled may be the portion that is irradiated at one end only of the instrument.

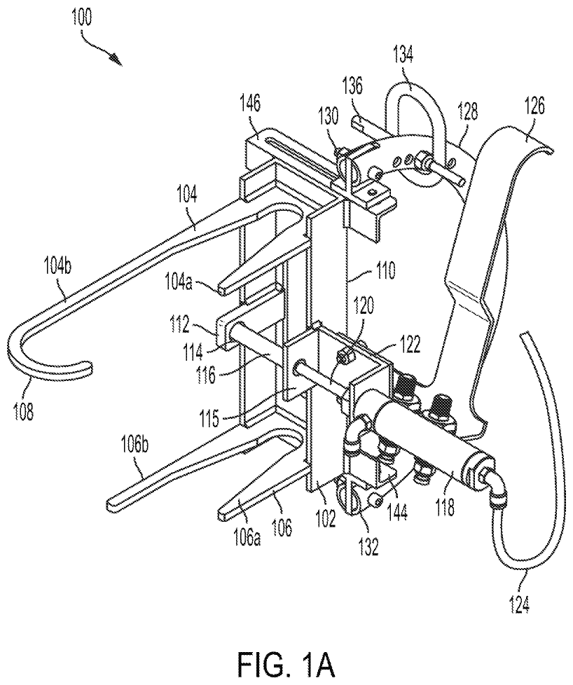

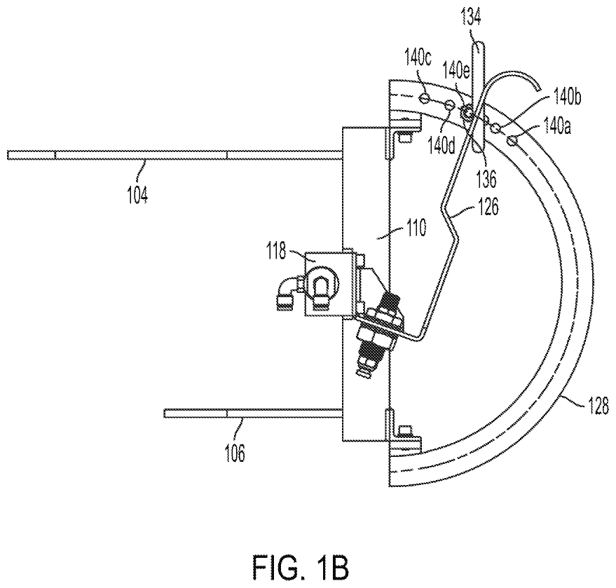

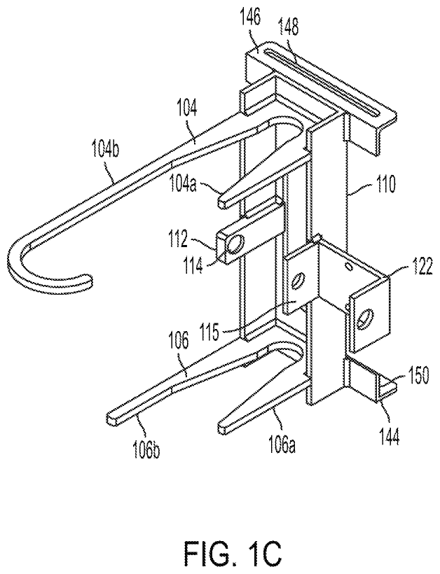

FIGS. 1A-C are various front perspective and side elevation views of a grapple device 100 in accordance with one example embodiment of the disclosure. Referring to FIGS. 1A-C, the grapple device 100, may include multiple components. Some of the components of the grapple device 100 may be included in a single weldment (assembly of parts joined by welding). In other examples, these components can be discrete and coupled together (e.g., via bolts, screws, rivets, welding, or any other known methods for coupling one component to another component).

The grapple device 100 may include a mounting plate 102. The mounting plate 102 may be any structural member configured to hold (e.g., have coupled thereto) other components in particular relative positions. The mounting plate 102 may be a single plate 110 or multiple plates 110 coupled together. For example, the mounting plate 102 may include a single plate 110 or multiple plates 110 coupled together to form a U-shaped or substantially U-shaped mounting plate 102. In other examples, the mounting plate 102 may be a piece of square tubing, a piece of rectangular tubing, a piece of round pipe, or any other structural member that may form a “back bone” for coupling other components to. For example, the mounting plate 102 may include a first plate having a first surface, an opposing second surface, a top edge, an opposing bottom edge, a first side edge and an opposing second side edge. A second plate may be coupled to the first side edge of the first plate and extend orthogonally or substantially orthogonally from the planar surfaces of the first plate. A third plate may be coupled to the second side edge of the first plate and extend orthogonally or substantially orthogonally from the planar surfaces of the first plate. For example, the second plate and the third plate may extend along parallel or substantially parallel planes. Each of the one or more plates 110 of the mounting plate 102 may include one or more planar surfaces. For example, each of the one or more plates 110 of the mounting plate 102 may include opposing planar or substantially planar surfaces. All or a portion of the mounting plate 102 may be made of metal, such as steel.

The grapple device 100 may also include a top fork 104 and a bottom fork 106. Each of the top fork 104 and the bottom fork 106 may be coupled (e.g., via bolts, screws, rivets, welding, or any other known methods for coupling one component to another component) to or integrally formed with the mounting plate 102. For example, the top fork 104 may be coupled to the mounting plate 102 near or adjacent to the top edge of the mounting plate and the bottom fork 106 may be coupled to the mounting plate 102 near or adjacent to the opposing bottom edge of the mounting plate. For example, each of the top fork 104 and the bottom fork 106 may be coupled to one or more of the first plate, second plate, or third plate of the mounting plate 102. The size of the top fork 104 and the bottom fork 106 may be the same or different. All or a portion of each of the top fork 104 and the bottom fork 106 may be made from metal, such as steel.

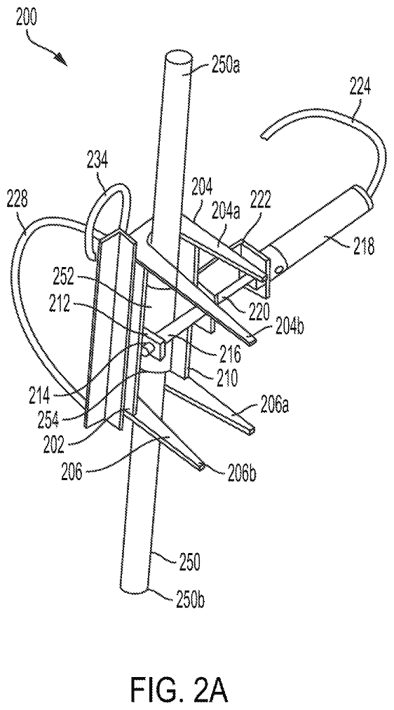

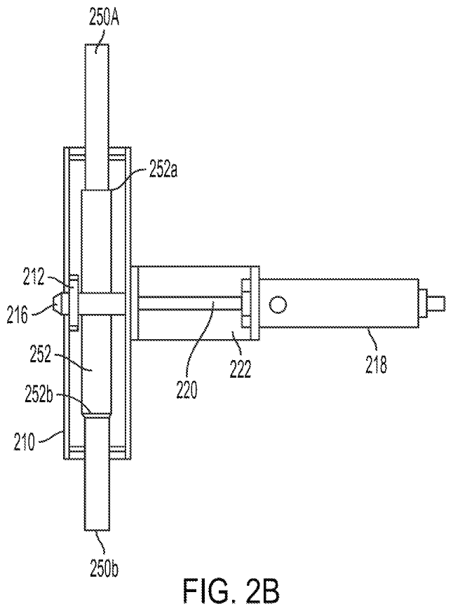

The top fork 104 may include two elongated members or tines. The elongated members or tines are configured to guide or funnel an instrument (e.g., the instrument 250 of FIG. 2A) into the area of the fork 104 having the fixed ends of the elongated members (e.g., where the elongated members or tines converge). For example, the top fork 104 may include a first elongated member 104a or tine and a second elongated member 104b or tine. The first elongated member 104a and the second elongated member 104b define a fork opening or open space between the first elongated member 104a and the second elongated member 104b. The opening or open space may be configured to receive all or at least a portion of an instrument (e.g., instrument 250 of FIG. 2A) between the first elongated member 104a and the second elongated member 104b. For example, the open space between the first elongated member 104a and the second elongated member 104b may be greater near the free ends of the first elongated member 104a and the second elongated member 104b and may be less adjacent the fixed ends of the first elongated member 104a and the second elongated member 104b. For example, the distance of the open space between and adjacent the fixed ends of the first elongated member 104a and the second elongated member 104b may be less than the diameter of a portion of the instrument 250 (e.g., the instrument boss 252) and greater than the diameter of another portion of the instrument 250 (e.g., the portions of the instrument 250 adjacent the instrument boss 252) to limit or prevent movement of the instrument between the top fork 104 and the bottom fork 106.

In one example, each of the first elongated member 104a and the second elongated member 104b may extend out from mounting plate 102 along parallel or substantially parallel axes. In another example, each of the first elongated member 104a and the second elongated member 104b may extend out from the mounting plate 102 in diverging angled paths (e.g., a v-shaped path). For example, the first elongated member 104a may extend out at an angle of anywhere in the range of 30-89 degrees and preferably within the range of 50-80 degrees and the second elongated member 104b may extend out at an angle of anywhere in the range of 91-150 degrees and preferably within the range of 100-130 degrees. Each of the first elongated member 104a and the second elongated member 104b may include a fixed end (e.g., adjacent the mounting plate 102) and a distal free end.

The length of the first elongated member 104a and the second elongated member 104b may be the same or different. For example, the length of the second elongated member 104b may be greater than the length of the first elongated member 104a. For example, the length of the second elongated member 104b may be at least twice the length of the first elongated member 104a. For example, the length of the second elongated member 104b may be between one and two times the length of the first elongated member 104a. The shape of the first elongated member 104a and the second elongated member 104b may be the same or different. For example, each of the first elongated member 104a and the second elongated member 104b may be wider adjacent to the fixed end of the corresponding first 104a or second 104b elongated member and may be narrower at the free end of the corresponding first 104a or second 104b elongated member.

The second elongated member 104b may include additional features not included on or with the first elongated member 104a. For example, the second elongated member 104b may also include an inwardly curved end member or hook-shaped member 108 along the distal free end of the second elongated member 104b. For example, the hook-shaped member 108 may curve inwardly towards the first elongated member 104a and then back towards the mounting plate 102. For example, the hook-shaped member 108 may have a curvature of between 90-180 degrees. For example, the hook-shaped member 108 may be U-shaped or substantially U-shaped and increase the length of the second elongated member 104b. The hook-shaped member 108 may have a diameter that is greater than the diameter of the instrument (e.g., the instrument 250 of FIG. 2A) that the grapple device 100 is intended to capture and lift. For example, the hook-shaped member 108 may be sized and shaped to help initially capture the instrument 250 for subsequently positioning a portion of the instrument 250 between the first elongated member 104a and the second elongated member 104b of the top fork 104. In certain examples, the position of the first elongated member 104a and the second elongated member 104b may be switched on the top fork 104.

The bottom fork 106 may include two elongated members or tines. The elongated members or tines are configured to guide or funnel an instrument (e.g., the instrument 250 of FIG. 2A) into the area of the fork 106 having the fixed ends of the elongated members (e.g., where the elongated members or tines converge). For example, the bottom fork 106 may include a first elongated member 106a or tine and a second elongated member 106b or tine. The first elongated member 106a and the second elongated member 106b define a fork opening or open space between the first elongated member 106a and the second elongated member 106b. The opening or open space may be configured to receive all or at least a portion of an instrument (e.g., instrument 250 of FIG. 2A) between the first elongated member 106a and the second elongated member 106b. For example, the open space between the first elongated member 106a and the second elongated member 106b may be greater near the free ends of the first elongated member 106a and the second elongated member 106b and may be less adjacent the fixed ends of the first elongated member 106a and the second elongated member 106b. For example, the distance D1 of the open space between and adjacent the fixed ends of the first elongated member 106a and the second elongated member 106b may be less than the diameter of a portion of the instrument 250 (e.g., the instrument boss 252) and greater than the diameter of another portion of the instrument 250 (e.g., the portions of the instrument 250 adjacent the instrument boss 252) to limit or prevent movement of the instrument between the top fork 104 and the bottom fork 106.

In one example, each of the first elongated member 106a and the second elongated member 106b may extend out from mounting plate 102 along parallel or substantially parallel axes. In another example, each of the first elongated member 106a and the second elongated member 106b may extend out from the mounting plate 102 in diverging angled paths (e.g., a v-shaped path). For example, the first elongated member 106a may extend out at an angle of anywhere in the range of 30-89 degrees and preferably within the range of 50-80 degrees and the second elongated member 106b may extend out at an angle of anywhere in the range of 91-150 degrees and preferably within the range of 100-130 degrees. Each of the first elongated member 106a and the second elongated member 106b may include a fixed end (e.g., adjacent the mounting plate 102) and a distal free end.

The length of the first elongated member 106a and the second elongated member 106b may be the same or different. For example, the length of the second elongated member 106b may be greater than the length of the first elongated member 106a. For example, the length of the second elongated member 106b may be between one and two times the length of the first elongated member 106a. The shape of the first elongated member 106a and the second elongated member 106b may be the same or different. For example, each of the first elongated member 106a and the second elongated member 106b may be wider adjacent to the fixed end of the corresponding first 106a or second 106b elongated member and may be narrower at the free end of the corresponding first 106a or second 106b elongated member. In certain examples, the position of the first elongated member 106a and the second elongated member 106b may be switched on the bottom fork 106.

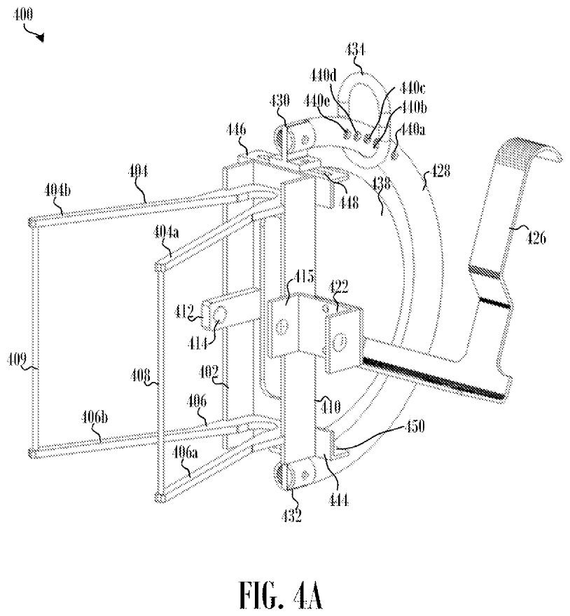

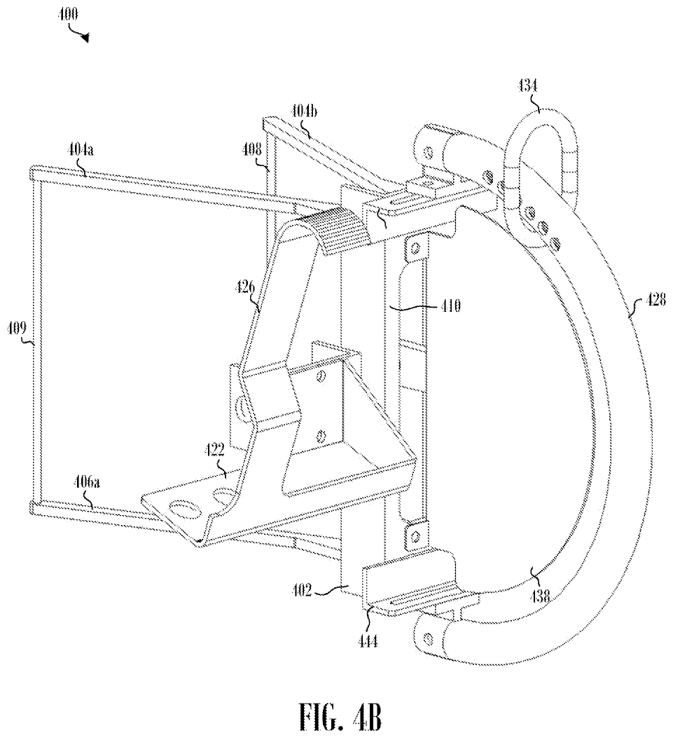

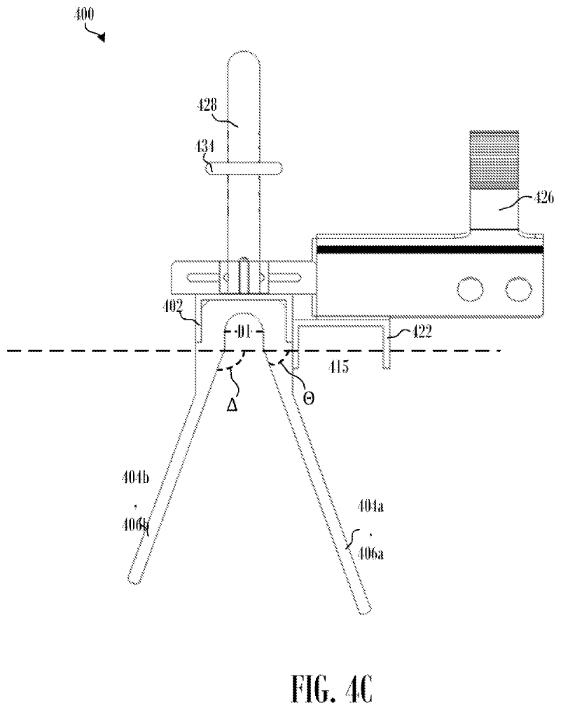

The grapple device 100 may also include an elongated member (e.g., the same or substantially similar to the elongated member 408 of FIG. 4A). The elongated member may extend from the first elongated member 104a of the top fork 104 to the first elongated member 106a of the bottom fork 106. For example, the elongated member may be coupled (e.g., via bolts, screws, rivets, welding, or any other known methods for coupling one component to another component) to the first elongated member 104a and the first elongated member 106a. For example, the elongated member may be coupled to or adjacent (e.g., within the first 0-12 inches of the free end) the free end of the first elongated member 104a and to or adjacent (e.g., within the first 0-12 inches of the free end) the free end of the first elongated member 106a. The elongated member may be configured to prevent the instrument (e.g., the instrument 250 of FIG. 2A) from having a portion of the instrument between the elongated members of one of the top fork 104 and the bottom fork 106 and another portion of the instrument outside of the elongated members of the other of the top fork 104 and the bottom fork 106. In another manner, the elongated member is configured to help guide the instrument between the elongated members of each of the top fork 104 and the bottom fork 106. The elongated member may be solid or tubular and may be cylindrical, square tubing, rectangular tubing, or any other type of elongated member. The elongated member may have a longitudinal axis that extends orthogonal to or substantially orthogonal to a longitudinal axis of each of the first elongated member 104a and the first elongated member 106a. In certain examples, the elongated member may be made of metal, such as steel.

The grapple device 100 may also include an elongated member (e.g., the same or substantially similar to the elongated member 409 of FIG. 4A). The elongated member may extend from the second elongated member 104b of the top fork 104 to the second elongated member 106b of the bottom fork 106. For example, the elongated member may be coupled (e.g., via bolts, screws, rivets, welding, or any other known methods for coupling one component to another component) to the second elongated member 104b and the second elongated member 106b. For example, the elongated member may be coupled to or adjacent (e.g., within the first 0-12 inches of the free end) the free end of the second elongated member 104b and to or adjacent (e.g., within the first 0-12 inches of the free end) the free end of the second elongated member 106b. The elongated member may be configured to prevent the instrument (e.g., the instrument 250 of FIG. 2A) from having a portion of the instrument between the elongated members of one of the top fork 104 and the bottom fork 106 and another portion of the instrument outside of the elongated members of the other of the top fork 104 and the bottom fork 106. In another manner, the elongated member is configured to help guide the instrument between the elongated members of each of the top fork 104 and the bottom fork 106. The elongated member may be solid or tubular and may be cylindrical, square tubing, rectangular tubing, or any other type of elongated member. The elongated member may have a longitudinal axis that extends orthogonal to or substantially orthogonal to a longitudinal axis of each of the second elongated member 104b and the second elongated member 106b. In certain examples, the elongated member may be made of metal, such as steel.

The grapple device 100 may also include a locking pin alignment plate 112. The locking pin alignment plate 112 may be coupled (e.g., via bolts, screws, rivets, welding, or any other known methods for coupling one component to another component) to or integrally formed with the mounting plate 102. For example, the locking pin alignment plate 112 may be coupled to the mounting plate 102 between the top fork 104 and the bottom fork 106. For example, the locking pin alignment plate 112 may be positioned between the second elongated member 104b or tine of the top fork 104 and the second elongated member 106b or tine of the bottom fork 106. The locking pin alignment plate 112 may extend out from the mounting plate 102 along a longitudinal axis parallel or substantially parallel to the longitudinal axes of the second elongated member 104b of the top fork 104 and the second elongated member 106b of the bottom fork 106. The locking pin alignment plate 112 may have planar or substantially planar interior-facing and opposing exterior-facing surfaces. The locking pin alignment plate 112 may include an aperture 114 that extends through all or at least a portion of the locking pin alignment plate 112 from the interior facing surface to the exterior-facing surface. The aperture 114 may have a longitudinal axis that extends orthogonal or substantially orthogonal to the longitudinal axes of the elongated members of the bottom fork 106. The aperture 114 may be sized and shaped to receive all or a portion of a corresponding locking pin 116 therein. The locking pin 116 may be configured to operate with the apertures in the locking pin alignment plate 112 and the rod alignment plate 115 (discussed below) to create a double shear connection for the locking pin 116 such that if a loss of pressure (e.g., air pressure or hydraulic pressure) to a cylinder 118 (discussed below) should occur, the loss of pressure will not cause the locking pin 116 to move out of the engaged position within the aperture 114 of the locking pin alignment plate 112.

The grapple device 100 may also include cylinder assembly coupled directly or indirectly to the mounting plate 102. For example, the cylinder assembly may include a mounting plate 122. The mounting plate 122 may be coupled (e.g., via bolts, screws, rivets, welding, or any other known methods for coupling one component to another component) to the mounting plate 102. The mounting plate 122 may include one or more alignment apertures for receiving a portion of a piston rod 120 of the cylinder 118 therethrough. For example, the mounting plate 122 may include a one or more rod alignment plates 115. The rod alignment plate 115 may include an aperture that extends through the rod alignment plate 115 and is configured to receive a portion of the cylinder rod 120 and/or the locking pin 116 therethrough.

The cylinder assembly may also include a cylinder 118 coupled (e.g., removably coupled) to the mounting plate 122. The cylinder 118 may be a pneumatic cylinder or a hydraulic cylinder. For example, the cylinder 118 may be a single-acting or double-acting cylinder.

The cylinder 118 may include a piston rod 120 that extends out from one end of the cylinder 118. The free end of the piston rod 120 may be coupled (e.g., via bolts, screws, rivets, welding, or any other known methods for coupling one component to another component) to the locking pin 116. In another example, the free end of the piston rod 120 may also be the locking pin 116. The locking pin 116 may extend from the free end of the piston rod 120 and have a longitudinal axis that is parallel or substantially parallel to the longitudinal axis of the piston rod 120. The piston rod 120 of the cylinder 118 may be configured to move from a first position, where the locking pin 116 is withdrawn or otherwise removed from the aperture 114 in the locking pin alignment plate 112 to a second position, where all or at least a portion of the locking pin 116 is inserted into the aperture 114 of the locking pin alignment plate 112. For example, when the top fork 104 and the bottom fork 106 of the grapple device 100 are placed about (e.g., one fork above the upper boss edge 252a and one fork below the lower boss edge 252b of) an instrument boss 252 (see FIGS. 2A and 2B) that is near the bottom of the cut or severed instrument portion, opposite the end that is irradiated, and the piston rod 120 of the cylinder 118 is stroked, the pin 116 may move from a first position (e.g., where the pin 116 is not inserted into the aperture 114 of the locking pin alignment plate 112) to a second position (e.g., where the pin 116 extends into the aperture 114 in the locking pin alignment plate 112) to capture a portion of the instrument (e.g., instrument 250 of FIG. 2A) within the grapple device 100 between the locking pin 116 and the forks 104, 106. When the grapple device 100 lifts the instrument 250, the forces on the pin 116 include shear forces that do not tend to back drive the piston rod 120 of the cylinder 118. As such, if a loss of pressure (e.g., air pressure or hydraulic pressure) to the cylinder 118 should occur, the loss of pressure will not cause the pin 116 to move out of the engaged position within the aperture 114 of the locking pin alignment plate 112.

The cylinder assembly may also include one or more supply hoses 124 coupled to the cylinder 118. Each supply hose 124 may be fluidicly coupled to the cylinder and may provide a supply of pressurized pneumatic air or hydraulic fluid to the cylinder 118 for movement of the piston rod 120. The cylinder assembly may also include a supply line bracket 126. The supply line bracket 126 may be coupled (e.g., via bolts, screws, rivets, welding, or any other known methods for coupling one component to another component) to the mounting plate 122 or the mounting plate 102. The supply line bracket 126 may include an elongated body having a fixed end coupled the mounting plate 122 or 102 and a distal free end. The free end of the supply line bracket 126 may be curved or hook-shaped and configured to keep the supply line(s) 124 on a particular side (e.g., along the back side of the mounting plate 102 opposite the top fork 104 and bottom fork 106) of the grapple device 100. The supply line bracket 126 may also provide a strain relief for the hose connections to the cylinder 118. In certain example embodiments, one or more supply hoses 124 may be coupled (e.g., temporarily connected) to the supply line bracket 126 to reduce or eliminate tension in the one or more supply hoses 124 and to prevent tension in the one or more supply hoses from being transferred to the hose connections or fittings coupled to the cylinder 118.

The grapple device 100 may also include a lifting assembly. The lifting assembly may be directly or indirectly coupled (e.g., via bolts, screws, rivets, welding, or any other known methods for coupling one component to another component) to the mounting plate 102. The lifting assembly may include a lifting bail 128. For example, the lifting bail may include a rod member 128. The rod member 128 may be solid or hollow (e.g., tubular). The rod member 128 may include a first end 130 and a distal second end 132.

The first end 130 of the rod member 128 may be disposed adjacent a top end of the mounting plate 102. For example, the first end 130 of the rod member 128 may be coupled directly or indirectly to the mounting plate 102 adjacent a top end of the mounting plate 102. For example, the lifting assembly may also include a mounting bracket 146. For example, the mounting bracket 146 may be an L-shaped mounting bracket. The L-shaped mounting bracket 146 may be coupled (e.g., via bolts, screws, rivets, welding, or any other known methods for coupling one component to another component) to the mounting plate 102 at or adjacent to the top end of the mounting plate 102. The L-shaped mounting bracket 146 may include an elongated mounting slot 148 extending through the L-shaped mounting bracket 146 (e.g., extending through one of the planar members of the mounting bracket 146). The first end 130 of the rod member 128 may be coupled (e.g., via bolts, screws, rivets, welding, or any other known methods for coupling one component to another component) to the L-shaped mounting bracket 146 and may be laterally adjustable with respect to the top end of the mounting plate 102 via the elongated mounting slot 148 of the L-shaped mounting bracket 146.

The second end 132 of the rod member 128 may be disposed adjacent a bottom end of the mounting plate 102. For example, the second end 132 of the rod member 128 may be coupled directly or indirectly to the mounting plate 102 adjacent a bottom end of the mounting plate 102. For example, the lifting assembly may also include a mounting bracket 144. For example, the mounting bracket 144 may be an L-shaped bracket. The L-shaped mounting bracket 144 may be coupled (e.g., via bolts, screws, rivets, welding, or any other known methods for coupling one component to another component) to the mounting plate 102 at or adjacent to the bottom end of the mounting plate 102. The L-shaped mounting bracket 144 may include an elongated mounting slot 150 extending through the L-shaped mounting bracket 144 (e.g., extending through one of the planar members of the mounting bracket 144). The second end 132 of the rod member 128 may be coupled (e.g., via bolts, screws, rivets, welding, or any other known methods for coupling one component to another component) to the L-shaped mounting bracket 144 and may be laterally adjustable with respect to the bottom end of the mounting plate 102 via the elongated mounting slot 150 of the L-shaped mounting bracket 144.

The rod member 128 may be shaped to support upending and inverting of the nuclear instruments. For example, the rod member 128 can have a curved shape, such as a continuously curved shape. For example, the rod member 128 may be curved or extend curvilinearly from its first end 130 to its second end 132 and may curve or extend curvilinearly from the top of the mounting plate 102 to the bottom of the mounting plate 102. For example, the curvature of the rod member 128 may be anywhere in the range of 135-225 degrees. For example, the curvature of the rod member 128 may be in the range of about 150-180 degrees.

The rod member 128 may include one or more apertures 140a-e or channels that extend through the rod member 128. The one or more apertures 140a-e may be positioned at different points along the circumference of the rod member 128. For example, the one or more apertures 140a-e may be offset one or more degrees (e.g., several degrees) from each other. For example, the angular offset for each of the one or more apertures 140a-e may be anywhere in the range of 5-10 degrees. For example, the one or more apertures 140a-e may be positioned near the first end 130 of the rod member 128 and/or closer to the first end 130 of the rod member 128 than the second end 132 of the rod member 128.

The one or more apertures 140a-e may each be sized, shaped, and configured to receive a pin 136 (e.g., a ring stop pin) therethrough. The pin 136 may be cylindrical member, a cotter pin, a bolt and nut, or another member that extends through one of the one or more apertures 140a-e. When positioned through one of the one or more apertures 140a-e, the pin 136 may extend out from each opposing side of the rod member 128 adjacent the respective one of the one or more apertures 140a-e. For example, the pin 136 may extend out from each opposing side of the rod member 128 for multiple inches. For example, the pin 136 may extend out from each opposing side of the rod member 128 anywhere in the range of 1-20 inches. For example, the pin may be removably positioned into any one of the one or more apertures 140a-e to adjust the angle that the grapple device 100 hangs prior to engagement with an instrument that it will grapple. For example, a forward tilt of the grapple device 100, that is when the top fork 104 is closer to the instrument than the bottom fork 106, may aid with installing the grapple device 100 over a portion of the instrument, such as an instrument boss (see e.g., instrument boss 252 of FIGS. 2A and 2B). With a forward tilt of the grapple device 100 established, initially only the top fork 104 will be place over the portion of the instrument (e.g., the instrument boss 252). Once the top fork 104 is over the portion of the instrument, and the supporting rope is lowered (e.g., tension on the supporting rope is reduced), gravity causes the grapple device 100 to rotate about the contact point of the top fork 104 with the instrument, allowing the bottom fork 106 to fully move into the engage position with the instrument (e.g., the instrument moves to a position between the elongated members 106a-b of the bottom fork 106).

The grapple device 100 may also include a planar or substantially planar member (e.g., the same or similar to the member 438 of FIG. 4A). The member may have a first planar or substantially planar surface and an opposing second planar or substantially planar surface. The member may be coupled to the mounting plate 102 and take up a majority of the space between the rod member 128 and the mounting plate 102. Further, the member and the rod member 128 may define a slot along which the ring member 134 may move along. In certain examples, the curvature of the edge of the member may match or be complementary to the curvature of the inner edge of the rod member 128. The member may be configured to reduce the speed at which the grapple device 100 rotates about a vertical axis defined by the rope, wire, or cable coupled to the ring member 134. For example, with its relatively large surface area in a vertical plane, the member hinders rotation of the grapple 100 by providing drag or resistance to motion through the water within which the instrument (e.g., the instrument 250 of FIG. 2A) is located. In certain examples, the member may be made of metal, such as steel and may be configured as sheet metal.

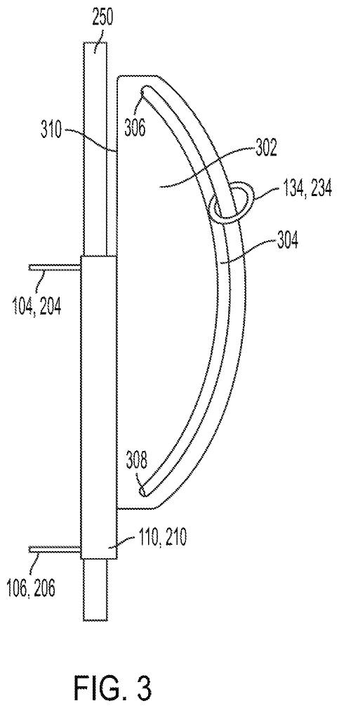

In another example, instead of a rod member 128, the lifting assembly may include a plate member 302 with an elongated slot 304 disposed within the plate member 302 (see FIG. 3). The plate member 302 may be directly or indirectly coupled (e.g., via bolts, screws, rivets, welding, or any other known methods for coupling one component to another component) to the mounting plate 102. For example, the plate member 302 may include a front edge or surface 310 that abuts or is positioned adjacent to the mounting plate 102 for coupling the plate member 302 to the mounting plate 102. The plate member 302 may include a first side planar surface and an opposing second side planar surface. Each of the first and second side planar surfaces may extend away from (e.g., orthogonally away from) at least a portion of the mounting plate 102 (such as orthogonally away from the center plate of the mounting plate 102).

The elongated slot 304 may have a first end 306 and a distal second end 308. The elongated slot 304 may be shaped to support upending and inverting of the nuclear instruments. For example, the elongated slot 304 may have a curved shape, such as a continuously curved shape. For example, the elongated slot 304 may be curved from its first end 306 to its second end 308. For example, the curvature of the elongated slot 304 may be anywhere in the range of 135-225 degrees. For example, the curvature of the elongated slot 304 may be in the range of about 150-180 degrees.

The lifting assembly may also include a ring member 134 or other attachment device that interacts with the rod member 128 or slot 304 of the plate member 302 (see FIG. 3). The ring member 134 may have a circular, oval, rounded rectangle, or other shape that defines an opening through the ring member 134. The ring member 134 may be configured to be removably coupled to a lifting line (e.g., a rope, wire, cable, line, etc.) and coupled to the rod member 128 or plate member 302 (see FIG. 3). For example, the opening may be sized and shaped to allow the ring member 134 to extend about the rod member 128. For example, the ring member 134 may be configured to slide along an inner circumferential surface of the rod member 128. The opening of the ring member 134 may also be sized and shaped to be less than the length of the pin 136. For example, when the pin 136 is inserted into one of the pin apertures 140a-e, the body of the ring member 134 may impact the pin 136 and prevent the ring member 134 from further moving along the rod member 128 in one direction. In another example, the opening of the ring member 134 may be sized and shaped to allow the ring member 134 to extend through the slot 304 (see FIG. 3) of the plate member 302. In this example, the ring member 134 may be configured to slide along the slot 304 of the plate member 302 from the first end 306 to the distal second end 308. For example the ring member 134 or other attachment device can be disposed about the rod member 128 or extend through the slot 304 of the plate member 302 (see FIG. 3) and move along the curvature (e.g., of the rod member 128 or slot 304) to assist with inverting the portion of the instrument (e.g., the instrument 250 of FIG. 2A). The ring member 134 may be constructed of metal, such as steel, or another material and may be made of one or multiple parts coupled together.

For example, a rope, wire, line, cable or the like (not shown) may be removably coupled to the ring member 134 or other attachment device for lifting the grapple device 100 and instrument (e.g., the instrument 250 of FIG. 2A). For example, as the rope and grapple device 100 is lifted, the ring member may slide along the curved surface of the rod member 128 or along the curved surface of the slot 304 of the plate member 302 (see FIG. 3) until the portion of the instrument 250 is fully raised from the reactor pool.

FIGS. 2A-B are front perspective and elevation views of a grapple device 200 in accordance with another example embodiment of the disclosure. Referring to FIGS. 2A-B, the grapple device 200, may include multiple components. Some of the components of the grapple device 200 may be included in a single weldment (assembly of parts joined by welding). In other examples, these components can be discrete and coupled together (e.g., via bolts, screws, rivets, welding, or any other known methods for coupling one component to another component).

The grapple device 200 may include a mounting plate 202. The mounting plate 202 may be any structural member configured to hold (e.g., have coupled thereto) other components in particular relative positions. The mounting plate 202 may be a single plate 210 or multiple plates 210 coupled together. For example, the mounting plate 202 may include a single plate 210 or multiple plates 210 coupled together to form a U-shaped or substantially U-shaped mounting plate 202. In other examples, the mounting plate 202 may be a piece of square tubing, a piece of rectangular tubing, a piece of round pipe, or any other structural member that may form a “back bone” for coupling other components to. For example, the mounting plate 202 may include a first plate having a first surface, an opposing second surface, a top edge, an opposing bottom edge, a first side edge and an opposing second side edge. A second plate may be coupled to the first side edge of the first plate and extend orthogonally or substantially orthogonally from the planar surfaces of the first plate. A third plate may be coupled to the second side edge of the first plate and extend orthogonally or substantially orthogonally from the planar surfaces of the first plate. For example, the second plate and the third plate may extend along parallel or substantially parallel planes. Each of the one or more plates 210 of the mounting plate 202 may include one or more planar surfaces. For example, each of the one or more plates 210 of the mounting plate 202 may include opposing planar or substantially planar surfaces. All or a portion of the mounting plate 202 may be made of metal, such as steel.

The grapple device 200 may also include a top fork 204 and a bottom fork 206. Each of the top fork 204 and the bottom fork 206 may be coupled (e.g., via bolts, screws, rivets, welding, or any other known methods for coupling one component to another component) to or integrally formed with the mounting plate 202. For example, the top fork 204 may be coupled to the mounting plate 202 near or adjacent to the top edge of the mounting plate 202 and the bottom fork 206 may be coupled to the mounting plate 202 near or adjacent to the opposing bottom edge of the mounting plate 202. For example, each of the top fork 204 and the bottom fork 206 may be coupled to one or more of the first plate, second plate, or third plate of the mounting plate 202. The size of the top fork 204 and the bottom fork 206 may be the same or different. All or a portion of each of the top fork 204 and the bottom fork 206 may be made from metal, such as steel.

The top fork 204 may include two elongated members or tines. The elongated members or tines are configured to guide or funnel an instrument (e.g., the instrument 250) into the area of the fork 204 having the fixed ends of the elongated members (e.g., where the elongated members or tines converge). For example, the top fork 204 may include a first elongated member 204a or tine and a second elongated member 204b or tine. The first elongated member 204a and the second elongated member 204b define a fork opening or open space between the first elongated member 204a and the second elongated member 204b. The opening or open space may be configured to receive all or at least a portion of an instrument (e.g., instrument 250) between the first elongated member 204a and the second elongated member 204b. For example, the open space between the first elongated member 204a and the second elongated member 204b may be greater near the free ends of the first elongated member 204a and the second elongated member 204b and may be less adjacent the fixed ends of the first elongated member 204a and the second elongated member 204b. For example, the distance of the open space between and adjacent the fixed ends of the first elongated member 204a and the second elongated member 204b may be less than the diameter of a portion of the instrument 250 (e.g., the instrument boss 252) and greater than the diameter of another portion of the instrument 250 (e.g., the portions of the instrument 250 adjacent the instrument boss 252) to limit or prevent movement of the instrument between the top fork 204 and the bottom fork 206.

In one example, each of the first elongated member 204a and the second elongated member 204b may extend out from mounting plate 202 along parallel or substantially parallel axes. In another example, each of the first elongated member 204a and the second elongated member 204b may extend out from the mounting plate 202 in diverging angled paths (e.g., a v-shaped path). For example, the first elongated member 204a may extend out at an angle of anywhere in the range of 30-89 degrees and preferably within the range of 50-80 degrees and the second elongated member 204b may extend out at an angle of anywhere in the range of 91-150 degrees and preferably within the range of 100-130 degrees. Each of the first elongated member 204a and the second elongated member 204b may include a fixed end (e.g., adjacent the mounting plate 202) and a distal free end.

The length of the first elongated member 204a and the second elongated member 204b may be the same or different. For example, the length of the second elongated member 204b may be greater than the length of the first elongated member 204a. For example, the length of the second elongated member 204b may be at least twice the length of the first elongated member 204a. For example, the length of the second elongated member 204b may be between one and two times the length of the first elongated member 204a. For example, the additional length of the second elongated member 204b help to initially contact and capture the instrument 250 for subsequently positioning a portion of the instrument 250 between the first elongated member 204a and the second elongated member 204b of the top fork 204.

The shape of the first elongated member 204a and the second elongated member 204b may be the same or different. For example, each of the first elongated member 204a and the second elongated member 204b may be wider adjacent to the fixed end of the corresponding first 204a or second 204b elongated member and may be narrower at the free end of the corresponding first 204a or second 204b elongated member. In certain examples, the position first elongated member 204a and the second elongated member 204b may be switched on the top fork 204.

The bottom fork 206 may include two elongated members or tines. The elongated members or tines are configured to guide or funnel an instrument (e.g., the instrument 250) into the area of the fork 206 having the fixed ends of the elongated members (e.g., where the elongated members or tines converge). For example, the bottom fork 206 may include a first elongated member 206a or tine and a second elongated member 206b or tine. The first elongated member 206a and the second elongated member 206b define a fork opening or open space between the first elongated member 206a and the second elongated member 206b. The opening or open space may be configured to receive all or at least a portion of an instrument (e.g., instrument 250) between the first elongated member 206a and the second elongated member 206b. For example, the open space between the first elongated member 206a and the second elongated member 206b may be greater near the free ends of the first elongated member 206a and the second elongated member 206b and may be less adjacent the fixed ends of the first elongated member 206a and the second elongated member 206b. For example, the distance of the open space between and adjacent the fixed ends of the first elongated member 206a and the second elongated member 206b may be less than the diameter of a portion of the instrument 250 (e.g., the instrument boss 252) and greater than the diameter of another portion of the instrument 250 (e.g., the portions of the instrument 250 adjacent the instrument boss 252) to limit or prevent movement of the instrument between the top fork 204 and the bottom fork 206.

In one example, each of the first elongated member 206a and the second elongated member 206b may extend out from mounting plate 202 along parallel or substantially parallel axes. In another example, each of the first elongated member 206a and the second elongated member 206b may extend out from the mounting plate 202 in diverging angled paths (e.g., a v-shaped path). For example, the first elongated member 206a may extend out at an angle of anywhere in the range of 30-89 degrees and preferably within the range of 50-80 degrees and the second elongated member 206b may extend out at an angle of anywhere in the range of 91-150 degrees and preferably within the range of 100-130 degrees. Each of the first elongated member 206a and the second elongated member 206b may include a fixed end (e.g., adjacent the mounting plate 202) and a distal free end.

The length of the first elongated member 206a and the second elongated member 206b may be the same or different. For example, the length of the second elongated member 206b may be greater than the length of the first elongated member 206a. For example, the length of the second elongated member 206b may be between one and two times the length of the first elongated member 206a. The shape of the first elongated member 106a and the second elongated member 206b may be the same or different. For example, each of the first elongated member 206a and the second elongated member 206b may be wider adjacent to the fixed end of the corresponding first 206a or second 206b elongated member and may be narrower at the free end of the corresponding first 206a or second 206b elongated member. In certain examples, the position of first elongated member 206a and the second elongated member 206b may be switched on the bottom fork 206.

The grapple device 200 may also include an elongated member (e.g., the same or substantially similar to the elongated member 408 of FIG. 4A). The elongated member may extend from the first elongated member 204a of the top fork 204 to the first elongated member 206a of the bottom fork 206. For example, the elongated member may be coupled (e.g., via bolts, screws, rivets, welding, or any other known methods for coupling one component to another component) to the first elongated member 204a and the first elongated member 206a. For example, the elongated member may be coupled to or adjacent (e.g., within the first 0-12 inches of the free end) the free end of the first elongated member 204a and to or adjacent (e.g., within the first 0-12 inches of the free end) the free end of the first elongated member 206a. The elongated member may be configured to prevent the instrument 250 from having a portion of the instrument 250 between the elongated members of one of the top fork 204 and the bottom fork 206 and another portion of the instrument 250 outside of the elongated members of the other of the top fork 204 and the bottom fork 206. In another manner, the elongated member is configured to help guide the instrument 250 between the elongated members of each of the top fork 204 and the bottom fork 206. The elongated member may be solid or tubular and may be cylindrical, square tubing, rectangular tubing, or any other type of elongated member. The elongated member may have a longitudinal axis that extends orthogonal to or substantially orthogonal to a longitudinal axis of each of the first elongated member 204a and the first elongated member 206a. In certain examples, the elongated member may be made of metal, such as steel.

The grapple device 100 may also include an elongated member (e.g., the same or substantially similar to the elongated member 409 of FIG. 4A). The elongated member may extend from the second elongated member 104b of the top fork 104 to the second elongated member 106b of the bottom fork 106. For example, the elongated member may be coupled (e.g., via bolts, screws, rivets, welding, or any other known methods for coupling one component to another component) to the second elongated member 104b and the second elongated member 106b. For example, the elongated member may be coupled to or adjacent (e.g., within the first 0-12 inches of the free end) the free end of the second elongated member 104b and to or adjacent (e.g., within the first 0-12 inches of the free end) the free end of the second elongated member 106b. The elongated member may be configured to prevent the instrument (e.g., the instrument 250 of FIG. 2A) from having a portion of the instrument between the elongated members of one of the top fork 104 and the bottom fork 106 and another portion of the instrument outside of the elongated members of the other of the top fork 104 and the bottom fork 106. In another manner, the elongated member is configured to help guide the instrument between the elongated members of each of the top fork 104 and the bottom fork 106. The elongated member may be solid or tubular and may be cylindrical, square tubing, rectangular tubing, or any other type of elongated member. The elongated member may have a longitudinal axis that extends orthogonal to or substantially orthogonal to a longitudinal axis of each of the second elongated member 104b and the second elongated member 106b. In certain examples, the elongated member may be made of metal, such as steel.

The grapple device 200 may also include a locking pin alignment plate 212. The locking pin alignment plate 212 may be coupled (e.g., via bolts, screws, rivets, welding, or any other known methods for coupling one component to another component) to or integrally formed with the mounting plate 202. For example, the locking pin alignment plate 212 may be coupled to the mounting plate 202 between the top fork 204 and the bottom fork 206. For example, the locking pin alignment plate 212 may be positioned between the second elongated member 204b or tine of the top fork 204 and the second elongated member 206b or tine of the bottom fork 206. The locking pin alignment plate 212 may extend out from the mounting plate 202 along a longitudinal axis parallel or substantially parallel to the longitudinal axes of the second elongated member 204b of the top fork 204 and the second elongated member 206b of the bottom fork 206. The locking pin alignment plate 212 may have planar or substantially planar interior-facing and opposing exterior-facing surfaces. The locking pin alignment plate 212 may include an aperture 214 that extends through all or at least a portion of the locking pin alignment plate 212 from the interior facing surface to the exterior-facing surface. The aperture 214 may have a longitudinal axis that extends orthogonal or substantially orthogonal to the longitudinal axes of the elongated members of the bottom fork 206. The aperture 214 may be sized and shaped to receive all or a portion of a corresponding locking pin 216 therein. The locking pin 216 may be configured to operate with the apertures in the locking pin alignment plate 212 and the rod alignment plate (discussed below) to create a double shear connection for the locking pin 216 such that if a loss of pressure (e.g., air pressure or hydraulic pressure) to a cylinder 218 (discussed below) should occur, the loss of pressure will not cause the locking pin 216 to move out of the engaged position within the aperture 214 of the locking pin alignment plate 212.

The grapple device 200 may also include cylinder assembly coupled directly or indirectly to the mounting plate 202. For example, the cylinder assembly may include a mounting plate 222. The mounting plate 222 may be coupled (e.g., via bolts, screws, rivets, welding, or any other known methods for coupling one component to another component) to the mounting plate 202. The mounting plate 222 may include one or more alignment apertures for receiving a portion of a piston rod 220 of the cylinder 218 therethrough. For example, the mounting plate 222 may include a one or more rod alignment plates (e.g., the same or similar to the rod alignment plate 115 of FIG. 1A). The rod alignment plate may include an aperture that extends through the rod alignment plate 115 and is configured to receive a portion of the cylinder rod 220 and/or the locking pin 216 therethrough.

The cylinder assembly may also include a cylinder 218 coupled (e.g., removably coupled) to the mounting plate 222. The cylinder 218 may be a pneumatic cylinder or a hydraulic cylinder. For example, the cylinder 218 may be a single-acting or double-acting cylinder.

The cylinder 218 may include a piston rod 220 that extends out from one end of the cylinder 218. The free end of the piston rod 220 may be coupled (e.g., via bolts, screws, rivets, welding, or any other known methods for coupling one component to another component) to the locking pin 216. In another example, the free end of the piston rod 220 may also be the locking pin 216. The locking pin 216 may extend from the free end of the piston rod 220 and have a longitudinal axis that is parallel or substantially parallel to the longitudinal axis of the piston rod 220. The piston rod 220 of the cylinder 218 may be configured to move from a first position, where the locking pin 216 is withdrawn or otherwise removed from the aperture 214 in the locking pin alignment plate 212 to a second position, where all or at least a portion of the locking pin 216 is inserted into the aperture 214 of the locking pin alignment plate 212. For example, when the top fork 204 and the bottom fork 206 of the grapple device 200 are placed about (e.g., one fork above the upper boss edge 252a and one fork below the lower boss edge 252b of) an instrument boss 252 between a top end 250a and an opposing bottom end 250b of the instrument 250 (e.g., a nuclear instrument) that is near the bottom of the cut or severed instrument portion, opposite the end that is irradiated, and the piston rod 220 of the cylinder 218 is stroked, the pin 216 may move from a first position (e.g., where the pin 216 is not inserted into the aperture 214 of the locking pin alignment plate 212) to a second position (e.g., where the pin 216 extends into the aperture 214 in the locking pin alignment plate 212) to capture a portion of the instrument 250 within the grapple device 200 between the locking pin 216 and the forks 204, 206. When the grapple device 200 lifts the instrument 250, the forces on the pin 216 include shear forces that do not tend to back drive the piston rod 220 of the cylinder 218. As such, if a loss of pressure (e.g., air pressure or hydraulic pressure) to the cylinder 218 should occur, the loss of pressure will not cause the pin 216 to move out of the engaged position within the aperture 214 of the locking pin alignment plate 212.

The cylinder assembly may also include one or more supply hoses 224 coupled to the cylinder 218. Each supply hose 224 may be fluidicly coupled to the cylinder and may provide a supply of pressurized pneumatic air or hydraulic fluid to the cylinder 218 for movement of the piston rod 220. The cylinder assembly may also include a supply line bracket (not shown) (e.g., the same or substantially similar to the supply line bracket 126 of FIG. 1A). The supply line bracket may be coupled (e.g., via bolts, screws, rivets, welding, or any other known methods for coupling one component to another component) to the mounting plate 222 or the mounting plate 202. The supply line bracket may include an elongated body having a fixed end coupled the mounting plate 222 or 202 and a distal free end. The free end of the supply line bracket may be curved or hook-shaped and configured to keep the supply line(s) 224 on a particular side (e.g., along the back side of the mounting plate 202 opposite the top fork 204 and bottom fork 206) of the grapple device 200. The supply line bracket may also provide a strain relief for the hose connections to the cylinder 218. In certain example embodiments, one or more supply hoses 224 may be coupled (e.g., temporarily connected) to the supply line bracket to reduce or eliminate tension in the one or more supply hoses 224 and to prevent tension in the one or more supply hoses from being transferred to the hose connections or fittings coupled to the cylinder 218.

The grapple device 200 may also include a lifting assembly. The lifting assembly may be directly or indirectly coupled (e.g., via bolts, screws, rivets, welding, or any other known methods for coupling one component to another component) to the mounting plate 202. The lifting assembly may include a lifting bail 228. For example, the lifting bail may include a rod member 228. The rod member 228 may be solid or hollow (e.g., tubular). The rod member 228 may include a first end and a distal second end.

The first end of the rod member 228 may be disposed adjacent atop end of the mounting plate 202. For example, the first end of the rod member 228 may be coupled directly or indirectly to the mounting plate 202 adjacent a top end of the mounting plate 202. For example, the lifting assembly may also include a mounting bracket. For example, the mounting bracket may be an L-shaped mounting bracket. The L-shaped mounting bracket may be coupled (e.g., via bolts, screws, rivets, welding, or any other known methods for coupling one component to another component) to the mounting plate 202 at or adjacent to the top end of the mounting plate 202. The L-shaped mounting bracket may include an elongated mounting slot extending through the L-shaped mounting bracket (e.g., extending through one of the planar members of the mounting bracket). The first end of the rod member 228 may be coupled (e.g., via bolts, screws, rivets, welding, or any other known methods for coupling one component to another component) to the L-shaped mounting bracket and may be laterally adjustable with respect to the top end of the mounting plate 202 via the elongated mounting slot of the L-shaped mounting bracket.

The second end of the rod member 228 may be disposed adjacent a bottom end of the mounting plate 202. For example, the second end of the rod member 228 may be coupled directly or indirectly to the mounting plate 202 adjacent a bottom end of the mounting plate 202. For example, the lifting assembly may also include a mounting bracket. For example, the mounting bracket may be an L-shaped bracket. The L-shaped mounting bracket may be coupled (e.g., via bolts, screws, rivets, welding, or any other known methods for coupling one component to another component) to the mounting plate 202 at or adjacent to the bottom end of the mounting plate 202. The L-shaped mounting bracket may include an elongated mounting slot extending through the L-shaped mounting bracket (e.g., extending through one of the planar members of the mounting bracket). The second end of the rod member 228 may be coupled (e.g., via bolts, screws, rivets, welding, or any other known methods for coupling one component to another component) to the L-shaped mounting bracket and may be laterally adjustable with respect to the bottom end of the mounting plate 202 via the elongated mounting slot of the L-shaped mounting bracket.

The rod member 228 may be shaped to support upending and inverting of the nuclear instruments 250. For example, the rod member 228 can have a curved shape, such as a continuously curved shape. For example, the rod member 228 may be curved or extend curvilinearly from its first end to its second end and may curve or extend curvilinearly from the top of the mounting plate 202 to the bottom of the mounting plate 202. For example, the curvature of the rod member 228 may be anywhere in the range of 135-225 degrees. For example, the curvature of the rod member 228 may be in the range of 150-180 degrees.

The rod member 228 may include one or more apertures or channels (e.g., such as apertures 140a-e of FIG. 1B) that extend through the rod member 228. The one or more apertures may be positioned at different points along the circumference of the rod member 228. For example, the one or more apertures may be offset one or more degrees (e.g., several degrees) from each other. For example, the angular offset for each of the one or more apertures may be anywhere in the range of 5-10 degrees. For example, the one or more apertures may be positioned near the first end of the rod member 228 and/or closer to the first end 2 of the rod member 228 than the second end of the rod member 228.

The one or more apertures may each be sized, shaped, and configured to receive a pin (e.g., a ring stop pin, such as pin 136 of FIG. 1A) therethrough. The pin may be cylindrical member, a cotter pin, a bolt and nut, or another member that extends through one of the one or more apertures. When positioned through one of the one or more apertures, the pin may extend out from each opposing side of the rod member 228 adjacent the respective one of the one or more apertures. For example, the pin may extend out from each opposing side of the rod member 228 anywhere in the range of 1-20 inches. For example, the pin may be removably positioned into any one of the one or more apertures to adjust the angle that the grapple device 200 hangs prior to engagement with an instrument that it will grapple. For example, a forward tilt of the grapple device 200, that is when the top fork 204 is closer to the instrument than the bottom fork 206, may aid with installing the grapple device 200 over a portion of the instrument, such as an instrument boss 252. With a forward tilt of the grapple device 200 established, initially only the top fork 204 will be place over the portion of the instrument (e.g., the instrument boss 252). Once the top fork 204 is over the portion of the instrument, and the supporting rope is lowered (e.g., tension on the supporting rope is reduced), gravity causes the grapple device 200 to rotate about the contact point of the top fork 204 with the instrument, allowing the bottom fork 206 to fully move into the engage position with the instrument (e.g., the instrument moves to a position between the elongated members 206a-b of the bottom fork 206).

The grapple device 200 may also include a planar or substantially planar member (e.g., the same or similar to the member 438 of FIG. 4A). The member may have a first planar or substantially planar surface and an opposing second planar or substantially planar surface. The member may be coupled to the mounting plate 202 and take up a majority of the space between the rod member 228 and the mounting plate 202. Further, the member and the rod member 228 may define a slot along which the ring member 234 may move along. In certain examples, the curvature of the edge of the member may match or be complementary to the curvature of the inner edge of the rod member 228. The member may be configured to reduce the speed at which the grapple device 200 rotates about a vertical axis defined by the rope, wire, or cable coupled to the ring member 234. For example, with its relatively large surface area in a vertical plane, the member hinders rotation of the grapple 200 by providing drag or resistance to motion through the water within which the instrument (e.g., the instrument 250) is located. In certain examples, the member may be made of metal, such as steel and may be configured as sheet metal.

In another example, instead of a rod member 228, the lifting assembly may include a plate member 302 with an elongated slot 304 disposed within the plate member 302 (see FIG. 3). The plate member 302 may be directly or indirectly coupled (e.g., via bolts, screws, rivets, welding, or any other known methods for coupling one component to another component) to the mounting plate 202. For example, the plate member 302 may include a front edge or surface 310 that abuts or is positioned adjacent to the mounting plate 202 for coupling the plate member 302 to the mounting plate 202. The plate member 302 may include a first side planar surface and an opposing second side planar surface. Each of the first and second side planar surfaces may extend away from (e.g., orthogonally away from) at least a portion of the mounting plate 202 (such as orthogonally away from the center plate of the mounting plate 202).

The elongated slot 304 may have a first end 306 and a distal second end 308. The elongated slot 304 may be shaped to support upending and inverting of the nuclear instruments 250. For example, the elongated slot 304 may have a curved shape, such as a continuously curved shape. For example, the elongated slot 304 may be curved from its first end 306 to its second end 308. For example, the curvature of the elongated slot 304 may be anywhere in the range of 135-225 degrees. For example, the curvature of the elongated slot 304 may be in the range of about 150-180 degrees.

The lifting assembly may also include a ring member 234 or other attachment device that interacts with the rod member 228 or slot 304 of the plate member 302 (see FIG. 3). The ring member 234 may have a circular, oval, rounded rectangle, or other shape that defines an opening through the ring member 234. The ring member 234 may be configured to be removably coupled to a lifting line (e.g., a rope, wire, cable, line, etc.) and coupled to the rod member 228 or plate member 302 (see FIG. 3). For example, the opening may be sized and shaped to allow the ring member 234 to extend about the rod member 228. For example, the ring member 234 may be configured to slide along an inner circumferential surface of the rod member 228. The opening of the ring member 234 may also be sized and shaped to be less than the length of the pin. For example, when the pin is inserted into one of the pin apertures (as shown in FIG. 1A), the body of the ring member 234 may impact the pin and prevent the ring member 234 from further moving along the rod member 228 in one direction. In another example, the opening of the ring member 234 may be sized and shaped to allow the ring member 234 to extend through the slot 304 (see FIG. 3) of the plate member 302. In this example, the ring member 234 may be configured to slide along the slot 304 of the plate member 302 from the first end 306 to the distal second end 308. For example the ring member 234 or other attachment device can be disposed about the rod member 228 or extend through the slot 304 of the plate member 302 (see FIG. 3) and move along the curvature (e.g., of the rod member 228 or slot 304) to assist with inverting the portion of the instrument 250. The ring member 234 may be constructed of metal, such as steel, or another material and may be made of one or multiple parts coupled together.

For example, a rope, wire, line, cable or the like (not shown) may be removably coupled to the ring member 234 or other attachment device for lifting the grapple device 200 and instrument 250. For example, as the rope and grapple device 200 is lifted, the ring member 234 may slide along the curved surface of the rod member 228 or along the curved surface of the slot 304 of the plate member 302 (see FIG. 3) until the portion of the instrument 250 is fully raised from the reactor pool.

FIGS. 4A-C are various perspective and top plan views of a grapple device 400 in accordance with one example embodiment of the disclosure. Referring to FIGS. 4A-C, the grapple device 400, may include multiple components. Some of the components of the grapple device 400 may be included in a single weldment (assembly of parts joined by welding). In other examples, these components can be discrete and coupled together (e.g., via bolts, screws, rivets, welding, or any other known methods for coupling one component to another component).

The grapple device 400 may include a mounting plate 402. The mounting plate 402 may be any structural member configured to hold (e.g., have coupled thereto) other components in particular relative positions. The mounting plate 402 may be a single plate 410 or multiple plates 410 coupled together. For example, the mounting plate 402 may include a single plate 410 or multiple plates 410 coupled together to form a U-shaped or substantially U-shaped mounting plate 402. In other examples, the mounting plate 402 may be a piece of square tubing, a piece of rectangular tubing, a piece of round pipe, or any other structural member that may form a “back bone” for coupling other components to. For example, the mounting plate 402 may include a first plate having a first surface, an opposing second surface, a top edge, an opposing bottom edge, a first side edge and an opposing second side edge. A second plate may be coupled to the first side edge of the first plate and extend orthogonally or substantially orthogonally from the planar surfaces of the first plate. A third plate may be coupled to the second side edge of the first plate and extend orthogonally or substantially orthogonally from the planar surfaces of the first plate. For example, the second plate and the third plate may extend along parallel or substantially parallel planes. Each of the one or more plates 410 of the mounting plate 402 may include one or more planar surfaces. For example, each of the one or more plates 410 of the mounting plate 402 may include opposing planar or substantially planar surfaces. All or a portion of the mounting plate 402 may be made of metal, such as steel.

The grapple device 400 may also include a top fork 404 and a bottom fork 406. Each of the top fork 404 and the bottom fork 406 may be coupled (e.g., via bolts, screws, rivets, welding, or any other known methods for coupling one component to another component) to or integrally formed with the mounting plate 402. For example, the top fork 404 may be coupled to the mounting plate 402 near or adjacent to the top edge of the mounting plate and the bottom fork 406 may be coupled to the mounting plate 402 near or adjacent to the opposing bottom edge of the mounting plate 402. For example, each of the top fork 404 and the bottom fork 406 may be coupled to one or more of the first plate, second plate, or third plate of the mounting plate 402. The size of the top fork 404 and the bottom fork 406 may be the same or different. All or a portion of each of the top fork 404 and the bottom fork 406 may be made from metal, such as steel.

The top fork 404 may include two elongated members or tines. The elongated members or tines are configured to guide or funnel an instrument (e.g., the instrument 250 of FIG. 2A) into the area of the fork 404 having the fixed ends of the elongated members (e.g., where the elongated members or tines converge). For example, the top fork 404 may include a first elongated member 404a or tine and a second elongated member 404b or tine. Each of the first elongated member 404a and the second elongated member 404b may include a fixed end (e.g., adjacent the mounting plate 402) and a distal free end. The first elongated member 404a and the second elongated member 404b define a fork opening or open space between the first elongated member 404a and the second elongated member 404b. The opening or open space may be configured to receive all or at least a portion of an instrument (e.g., instrument 250 of FIG. 2A) between the first elongated member 404a and the second elongated member 404b. For example, the open space between the first elongated member 404a and the second elongated member 404b may be greater near the free ends of the first elongated member 404a and the second elongated member 404b and may be less adjacent the fixed ends of the first elongated member 404a and the second elongated member 404b. For example, the distance D1 of the open space between and adjacent the fixed ends of the first elongated member 404a and the second elongated member 404b may be less than the diameter of a portion of the instrument 250 (e.g., the instrument boss 252) and greater than the diameter of another portion of the instrument 250 (e.g., the portions of the instrument 250 adjacent the instrument boss 252) to limit or prevent movement of the instrument between the top fork 404 and the bottom fork 406.

In one example, each of the first elongated member 404a and the second elongated member 404b may extend out from the mounting plate 102 in diverging angled paths (e.g., a v-shaped path). For example, the first elongated member 404a may extend out at an angle Θ of anywhere in the range of 30-89 degrees and preferably within the range of 50-80 degrees and the second elongated member 404b may extend out at an angle A of anywhere in the range of 91-150 degrees and preferably within the range of 100-130 degrees. In another example, each of the first elongated member 404a and the second elongated member 404b may extend out from mounting plate 402 along parallel or substantially parallel axes.

The length of the first elongated member 404a and the second elongated member 404b may be the same or different. For example, the length of the second elongated member 404b may be greater than the length of the first elongated member 404a or vice-versa. The shape of the first elongated member 404a and the second elongated member 404b may be the same or different. For example, each of the first elongated member 404a and the second elongated member 404b may be wider adjacent to the fixed end of the corresponding first 404a or second 404b elongated member and may be narrower at the free end of the corresponding first 404a or second 404b elongated member.

In certain embodiments, the second elongated member 404b may include additional features not included on or with the first elongated member 404a. For example, the second elongated member 404b may also include an inwardly curved end member or hook-shaped member (e.g., similar to the hook-shaped member 108 of FIG. 1A) along the distal free end of the second elongated member 404b. For example, the hook-shaped member may curve inwardly towards the first elongated member 404a and then back towards the mounting plate 402. For example, the hook-shaped member may have a curvature of between 90-180 degrees. For example, the hook-shaped member may be U-shaped or substantially U-shaped and increase the length of the second elongated member 404b. For example, the hook-shaped member may be sized and shaped to help initially capture the instrument 250 (of FIG. 2A) for subsequently positioning a portion of the instrument 250 between the first elongated member 404a and the second elongated member 404b of the top fork 404. In certain examples, the position of the first elongated member 404a and the second elongated member 404b may be switched on the top fork 404.

The bottom fork 406 may include two elongated members or tines. The elongated members or tines are configured to guide or funnel an instrument (e.g., the instrument 250 of FIG. 2A) into the area of the fork 406 having the fixed ends of the elongated members (e.g., where the elongated members or tines converge). For example, the bottom fork 406 may include a first elongated member 406a or tine and a second elongated member 406b or tine. Each of the first elongated member 406a and the second elongated member 406b may include a fixed end (e.g., adjacent the mounting plate 102) and a distal free end. The first elongated member 406a and the second elongated member 406b define a fork opening or open space between the first elongated member 406a and the second elongated member 406b. The opening or open space may be configured to receive all or at least a portion of an instrument (e.g., the instrument 250 of FIG. 2A) between the first elongated member 406a and the second elongated member 406b. For example, the open space between the first elongated member 406a and the second elongated member 406b may be greater near the free ends of the first elongated member 406a and the second elongated member 406b and may be less adjacent the fixed ends of the first elongated member 406a and the second elongated member 4046b. For example, the distance D1 of the open space between and adjacent the fixed ends of the first elongated member 406a and the second elongated member 406b may be less than the diameter of a portion of the instrument 250 (e.g., the instrument boss 252) and greater than the diameter of another portion of the instrument 250 (e.g., the portions of the instrument 250 adjacent the instrument boss 252) to limit or prevent movement of the instrument between the top fork 404 and the bottom fork 406.

In one example, each of the first elongated member 406a and the second elongated member 406b may extend out from the mounting plate 402 in diverging angled paths (e.g., a v-shaped path). For example, the first elongated member 406a may extend out at an angle Θ of anywhere in the range of 30-89 degrees, and preferably within the range of 50-80 degrees, and the second elongated member 406b may extend out at an angle A of anywhere in the range of 91-150 degrees, and preferably within the range of 100-130 degrees. In another example, each of the first elongated member 406a and the second elongated member 406b may extend out from mounting plate 102 along parallel or substantially parallel axes.

The length of the first elongated member 406a and the second elongated member 406b may be the same or different. For example, the length of the second elongated member 406b may be greater than the length of the first elongated member 406a or vice-versa. The shape of the first elongated member 406a and the second elongated member 406b may be the same or different. For example, each of the first elongated member 406a and the second elongated member 406b may be wider adjacent to the fixed end of the corresponding first 406a or second 406b elongated member and may be narrower at the free end of the corresponding first 406a or second 406b elongated member. In certain examples, the position of the first elongated member 406a and the second elongated member 406b may be switched on the bottom fork 406.

The grapple device 400 may also include an elongated member 408. The elongated member may extend from the first elongated member 404a of the top fork 404 to the first elongated member 406a of the bottom fork 406. For example, the elongated member 408 may be coupled (e.g., via bolts, screws, rivets, welding, or any other known methods for coupling one component to another component) to the first elongated member 404a and the first elongated member 406a. For example, the elongated member 408 may be coupled to or adjacent (e.g., within the first 0-12 inches of the free end) the free end of the first elongated member 404a and to or adjacent (e.g., within the first 0-12 inches of the free end) the free end of the first elongated member 406a. The elongated member 408 may be configured to prevent the instrument (e.g., the instrument 250 of FIG. 2A) from having a portion of the instrument between the elongated members of one of the top fork 404 and the bottom fork 406 and another portion of the instrument outside of the elongated members of the other of the top fork 404 and the bottom fork 406. In another manner, the elongated member 408 is configured to help guide the instrument between the elongated members of each of the top fork 404 and the bottom fork 406. The elongated member 408 may be solid or tubular and may be cylindrical, square tubing, rectangular tubing, or any other type of elongated member. The elongated member 408 may have a longitudinal axis that extends orthogonal to or substantially orthogonal to a longitudinal axis of each of the first elongated member 404a and the first elongated member 406a. In certain examples, the elongated member 408 may be made of metal, such as steel.

The grapple device 400 may also include an elongated member 409. The elongated member may extend from the second elongated member 404b of the top fork 404 to the second elongated member 406b of the bottom fork 406. For example, the elongated member 409 may be coupled (e.g., via bolts, screws, rivets, welding, or any other known methods for coupling one component to another component) to the second elongated member 404b and the second elongated member 406b. For example, the elongated member 409 may be coupled to or adjacent (e.g., within the first 0-12 inches of the free end) the free end of the second elongated member 404b and to or adjacent (e.g., within the first 0-12 inches of the free end) the free end of the second elongated member 406b. The elongated member 409 may be configured to prevent the instrument (e.g., the instrument 250 of FIG. 2A) from having a portion of the instrument between the elongated members of one of the top fork 404 and the bottom fork 406 and another portion of the instrument outside of the elongated members of the other of the top fork 404 and the bottom fork 406. In another manner, the elongated member 409 is configured to help guide the instrument between the elongated members of each of the top fork 404 and the bottom fork 406. The elongated member 409 may be solid or tubular and may be cylindrical, square tubing, rectangular tubing, or any other type of elongated member. The elongated member 409 may have a longitudinal axis that extends orthogonal to or substantially orthogonal to a longitudinal axis of each of the second elongated member 404b and the second elongated member 406b. In certain examples, the elongated member 409 may be made of metal, such as steel.

The grapple device 400 may also include a locking pin alignment plate 412. The locking pin alignment plate 412 may be coupled (e.g., via bolts, screws, rivets, welding, or any other known methods for coupling one component to another component) to or integrally formed with the mounting plate 402. For example, the locking pin alignment plate 412 may be coupled to the mounting plate 402 between the top fork 404 and the bottom fork 406. For example, the locking pin alignment plate 412 may be positioned between the second elongated member 404b or tine of the top fork 404 and the second elongated member 406b or tine of the bottom fork 406. The locking pin alignment plate 412 may extend out from the mounting plate 402 along a longitudinal axis parallel or substantially parallel to the longitudinal axes of the second elongated member 404b of the top fork 404 and the second elongated member 406b of the bottom fork 406. The locking pin alignment plate 412 may have planar or substantially planar interior-facing and opposing exterior-facing surfaces.

The locking pin alignment plate 412 may include an aperture 414 that extends through all or at least a portion of the locking pin alignment plate 412 from the interior facing surface to the exterior-facing surface. The aperture 414 may have a longitudinal axis that extends orthogonally or substantially orthogonally to the longitudinal axes of the elongated members of the bottom fork 406. The aperture 414 may be sized and shaped to receive all or a portion of a corresponding locking pin (e.g., the same or substantially similar to the locking pin 116 of FIG. 1A) therein. The locking pin may be configured to operate with the apertures in the locking pin alignment plate 412 and the rod alignment plate 415 (discussed below) to create a double shear connection for the locking pin such that if a loss of pressure (e.g., air pressure or hydraulic pressure) to a cylinder (discussed below) should occur, the loss of pressure will not cause the locking pin to move out of the engaged position within the aperture 414 of the locking pin alignment plate 412.

The grapple device 400 may also include cylinder assembly coupled directly or indirectly to the mounting plate 402. For example, the cylinder assembly may include a mounting plate 422. The mounting plate 422 may be coupled (e.g., via bolts, screws, rivets, welding, or any other known methods for coupling one component to another component) to the mounting plate 402. The mounting plate 422 may include one or more alignment apertures for receiving a portion of a piston rod (e.g., the piston rod 120 of FIG. 1) of the cylinder (e.g., the same or substantially similar to the cylinder 118 of FIG. 1) therethrough. For example, the mounting plate 422 may include a one or more rod alignment plates 415. The rod alignment plate 415 may include an aperture that extends through the rod alignment plate 415 and is configured to receive a portion of the piston rod and/or the locking pin therethrough.

The cylinder assembly may also include a cylinder (e.g., the same or substantially similar to the cylinder 118 of FIG. 1) coupled (e.g., removably coupled) to the mounting plate 422. The cylinder may be a pneumatic cylinder or a hydraulic cylinder. For example, the cylinder may be a single-acting or double-acting cylinder.

The cylinder may include the piston rod that extends out from one end of the cylinder. The free end of the piston rod may be coupled (e.g., via bolts, screws, rivets, welding, or any other known methods for coupling one component to another component) to the locking pin. In another example, the free end of the piston rod may also be the locking pin. The locking pin may extend from the free end of the piston rod and have a longitudinal axis that is parallel or substantially parallel to the longitudinal axis of the piston rod. The piston rod of the cylinder may be configured to move from a first position, where the locking pin is withdrawn or otherwise removed from the aperture 414 in the locking pin alignment plate 412 to a second position, where all or at least a portion of the locking pin is inserted into the aperture 414 of the locking pin alignment plate 412. For example, when the top fork 404 and the bottom fork 406 of the grapple device 400 are placed about (e.g., one fork above the upper boss edge 252a and one fork below the lower boss edge 252b of) an instrument boss 252 (see FIGS. 2A and 2B) that is near the bottom of the cut or severed instrument portion, opposite the end that is irradiated, and the piston rod of the cylinder is stroked, the pin may move from a first position (e.g., where the pin is not inserted into the aperture 414 of the locking pin alignment plate 412) to a second position (e.g., where the pin extends into the aperture 414 in the locking pin alignment plate 412) to capture a portion of the instrument (e.g., instrument 250 of FIG. 2A) within the grapple device 400 between the locking pin and the forks 404, 406. When the grapple device 400 lifts the instrument 250, the forces on the pin include shear forces that do not tend to back drive the piston rod of the cylinder. As such, if a loss of pressure (e.g., air pressure or hydraulic pressure) to the cylinder should occur, the loss of pressure will not cause the pin to move out of the engaged position within the aperture 414 of the locking pin alignment plate 412.

The cylinder assembly may also include one or more supply hoses (e.g., the same or similar to the supply hoses 124 of FIG. 1) coupled to the cylinder. Each supply hose may be fluidicly coupled to the cylinder and may provide a supply of pressurized pneumatic air or hydraulic fluid to the cylinder for movement of the piston rod. The cylinder assembly may also include a supply line bracket 426. The supply line bracket 426 may be coupled (e.g., via bolts, screws, rivets, welding, or any other known methods for coupling one component to another component) to the mounting plate 422 or the mounting plate 402. The supply line bracket 426 may include an elongated body having a fixed end coupled the mounting plate 422 or 402 and a distal free end. The free end of the supply line bracket 426 may be curved or hook-shaped and configured to keep the supply line(s) on a particular side (e.g., along the back side of the mounting plate 402 opposite the top fork 404 and bottom fork 406) of the grapple device 400. The supply line bracket 426 may also provide a strain relief for the hose connections to the cylinder. In certain example embodiments, one or more supply hoses may be coupled (e.g., temporarily connected) to the supply line bracket 426 to reduce or eliminate tension in the one or more supply hoses and to prevent tension in the one or more supply hoses from being transferred to the hose connections or fittings coupled to the cylinder.

The grapple device 400 may also include a lifting assembly. The lifting assembly may be directly or indirectly coupled (e.g., via bolts, screws, rivets, welding, or any other known methods for coupling one component to another component) to the mounting plate 402. The lifting assembly may include a lifting bail 428. For example, the lifting bail may include a rod member 428. The rod member 428 may be solid or hollow (e.g., tubular). The rod member 428 may include a first end 430 and a distal second end 432.

The first end 430 of the rod member 428 may be disposed adjacent a top end of the mounting plate 402. For example, the first end 430 of the rod member 428 may be coupled directly or indirectly to the mounting plate 402 adjacent a top end of the mounting plate 402. For example, the lifting assembly may also include a mounting bracket 446. For example, the mounting bracket 446 may be an L-shaped mounting bracket. The L-shaped mounting bracket 446 may be coupled (e.g., via bolts, screws, rivets, welding, or any other known methods for coupling one component to another component) to the mounting plate 402 at or adjacent to the top end of the mounting plate 402. The L-shaped mounting bracket 446 may include an elongated mounting slot 448 extending through the L-shaped mounting bracket 446 (e.g., extending through one of the planar members of the mounting bracket 446). The first end 430 of the rod member 428 may be coupled (e.g., via bolts, screws, rivets, welding, or any other known methods for coupling one component to another component) to the L-shaped mounting bracket 446 and may be laterally adjustable with respect to the top end of the mounting plate 402 via the elongated mounting slot 448 of the L-shaped mounting bracket 446.

The second end 432 of the rod member 428 may be disposed adjacent a bottom end of the mounting plate 402. For example, the second end 432 of the rod member 428 may be coupled directly or indirectly to the mounting plate 402 adjacent a bottom end of the mounting plate 402. For example, the lifting assembly may also include a mounting bracket 444. For example, the mounting bracket 444 may be an L-shaped bracket. The L-shaped mounting bracket 444 may be coupled (e.g., via bolts, screws, rivets, welding, or any other known methods for coupling one component to another component) to the mounting plate 402 at or adjacent to the bottom end of the mounting plate 402. The L-shaped mounting bracket 444 may include an elongated mounting slot 450 extending through the L-shaped mounting bracket 444 (e.g., extending through one of the planar members of the mounting bracket 444). The second end 432 of the rod member 428 may be coupled (e.g., via bolts, screws, rivets, welding, or any other known methods for coupling one component to another component) to the L-shaped mounting bracket 444 and may be laterally adjustable with respect to the bottom end of the mounting plate 402 via the elongated mounting slot 450 of the L-shaped mounting bracket 444.

The rod member 428 may be shaped to support upending and inverting of instruments (e.g., the nuclear instruments, such as instrument 250 of FIG. 2A). For example, the rod member 428 can have a curved shape, such as a continuously curved shape from its first end 430 to its second end 432. For example, the rod member 428 may be curved or extend curvilinearly from its first end 430 to its second end 432 and may curve or extend curvilinearly from the top of the mounting plate 402 to the bottom of the mounting plate 402. For example, the curvature of the rod member 428 may be anywhere in the range of 135-225 degrees. For example, the curvature of the rod member 428 may be in the range of about 150-180 degrees.

The rod member 428 may include one or more apertures 440a-e or channels that extend through the rod member 428. The one or more apertures 440a-e may be positioned at different points along the circumference of the rod member 428. For example, the one or more apertures 440a-e may be offset one or more degrees (e.g., several degrees) from each other. For example, the angular offset for each of the one or more apertures 440a-e may be anywhere in the range of 5-10 degrees. For example, the one or more apertures 440a-e may be positioned near the first end 430 of the rod member 428 and/or closer to the first end 430 of the rod member 428 than the second end 432 of the rod member 428.

The one or more apertures 440a-e may each be sized, shaped, and configured to receive a pin (e.g., the same or substantially similar to the pin 136 of FIG. 1), such as a ring stop pin, therethrough. The pin may be cylindrical member, a cotter pin, a bolt and nut, or another member that extends through one of the one or more apertures 440a-e. When positioned through one of the one or more apertures 440a-e, the pin may extend out from each opposing side of the rod member 428 adjacent the respective one of the one or more apertures 440a-e. For example, the pin may extend out from each opposing side of the rod member 428 for multiple inches. For example, the pin may extend out from each opposing side of the rod member 428 anywhere in the range of 1-20 inches. For example, the pin may be removably positioned into any one of the one or more apertures 440a-e to adjust the angle that the grapple device 400 hangs prior to engagement with an instrument that it will grapple. For example, a forward tilt of the grapple device 400, that is when the top fork 404 is closer to the instrument than the bottom fork 406, may aid with installing the grapple device 400 over a portion of the instrument, such as an instrument boss (see e.g., instrument boss 252 of FIGS. 2A and 2B). With a forward tilt of the grapple device 400 established, initially only the top fork 404 will be place over the portion of the instrument (e.g., the instrument boss 252). Once the top fork 404 is over the portion of the instrument, and the supporting rope is lowered (e.g., tension on the supporting rope is reduced), gravity causes the grapple device 400 to rotate about the contact point of the top fork 404 with the instrument, allowing the bottom fork 406 to fully move into the engage position with the instrument (e.g., the instrument moves to a position between the elongated members 406a-b of the bottom fork 406).

The grapple device 400 may also include a planar or substantially planar member 438. The member 438 may have a first planar or substantially planar surface and an opposing second planar or substantially planar surface. The member 438 may be coupled to the mounting plate 402 and take up a majority of the space between the rod member 428 and the mounting plate 402. Further, the member 438 and the rod member 428 may define a slot along which the ring member 434 may move along. In certain examples, the curvature of the edge of the member 438 may match or be complementary to the curvature of the inner edge of the rod member 428. The member 438 may be configured to reduce the speed at which the grapple device 400 rotates about a vertical axis defined by the rope, wire, or cable coupled to the ring member 434. For example, with its relatively large surface area in a vertical plane, the member 438 hinders rotation of the grapple 400 by providing drag or resistance to motion through the water within which the instrument (e.g., the instrument 250 of FIG. 2A) is located. In certain examples, the member 438 may be made of metal, such as steel and may be configured as sheet metal.

In another example, instead of a rod member 428, the lifting assembly may include a plate member 302 with an elongated slot 304 disposed within the plate member 302 (see FIG. 3). The plate member 302 may be directly or indirectly coupled (e.g., via bolts, screws, rivets, welding, or any other known methods for coupling one component to another component) to the mounting plate 402. For example, the plate member 302 may include a front edge or surface 310 that abuts or is positioned adjacent to the mounting plate 402 for coupling the plate member 302 to the mounting plate 402. The plate member 302 may include a first side planar surface and an opposing second side planar surface. Each of the first and second side planar surfaces may extend away from (e.g., orthogonally away from) at least a portion of the mounting plate 402 (such as orthogonally away from the center plate of the mounting plate 402).

The elongated slot 304 may have a first end 306 and a distal second end 308. The elongated slot 304 may be shaped to support upending and inverting of the nuclear instruments. For example, the elongated slot 304 may have a curved shape, such as a continuously curved shape. For example, the elongated slot 304 may be curved from its first end 306 to its second end 308. For example, the curvature of the elongated slot 304 may be anywhere in the range of 135-225 degrees. For example, the curvature of the elongated slot 304 may be in the range of about 150-180 degrees.

The lifting assembly may also include a ring member 434 or other attachment device that interacts with the rod member 428 or slot 304 of the plate member 302 (see FIG. 3). The ring member 434 may have a circular, oval, rounded rectangle, or other shape that defines an opening through the ring member 434. The ring member 434 may be configured to be removably coupled to a lifting line (e.g., a rope, wire, cable, line, etc.) and coupled to the rod member 428 or plate member 302 (see FIG. 3). For example, the opening may be sized and shaped to allow the ring member 434 to extend about the rod member 428. For example, the ring member 434 may be configured to slide along an inner circumferential surface of the rod member 428. The opening of the ring member 434 may also be sized and shaped to be less than the length of the pin. For example, when the pin is inserted into one of the pin apertures 440a-e, the body of the ring member 434 may impact the pin and prevent the ring member 434 from further moving along the rod member 428 in one direction. In another example, the opening of the ring member 434 may be sized and shaped to allow the ring member 434 to extend through the slot 304 (see FIG. 3) of the plate member 302. In this example, the ring member 434 may be configured to slide along the slot 304 of the plate member 302 from the first end 306 to the distal second end 308. For example the ring member 434 or other attachment device can be disposed about the rod member 428 or extend through the slot 304 of the plate member 302 (see FIG. 3) and move along the curvature (e.g., of the rod member 428 or slot 304) to assist with inverting the portion of the instrument (e.g., the instrument 250 of FIG. 2A). The ring member 434 may be constructed of metal, such as steel, or another material and may be made of one or multiple parts coupled together.

For example, a rope, wire, line, cable or the like (not shown) may be removably coupled to the ring member 434 or other attachment device for lifting the grapple device 400 and instrument (e.g., the instrument 250 of FIG. 2A). For example, as the rope and grapple device 400 is lifted, the ring member may slide along the curved surface of the rod member 428 or along the curved surface of the slot 304 of the plate member 302 (see FIG. 3) until the portion of the instrument 250 is fully raised from the reactor pool (and another portion of the instrument 250, such as the portion having the irradiated end, remains within the reactor pool).

An example method for using the grapple device 100, 200 is described below. Referring to FIGS. 1A-3, in preparation for use, a long rope (not shown) can be securely coupled to a ring member 134, 234 on the lifting bail. The ring member 134, 234, to which the rope is attached, may be pinned to the desired starting position along the rod member 228 or slot 304 with a ring stop pin 136 to ensure that the grapple device 100, 200 has the desired initial forward tilt (e.g., the top fork 104, 204 extending outward further than bottom fork 106, 206). A regulated source of air or fluid is attached to the air or fluid fittings fluidicly coupled to the cylinder 118, 218 of the grapple device 100, 200. The cylinder 118, 218 may be tested to ensure proper cylinder stroke of the cylinder rod 120, 220 and attached pin 116, 216 and no apparent air or fluid leakage. By paying out rope, the grapple device 100, 200 is lowered under the water to the depth of a lower end of a spent nuclear instrument (e.g., the instrument 250) which would have previously been suspended from a different grapple coupled to the upper end of the instrument 250. Using the rope and an air line, the rotational orientation of the grapple device 100, 200 may be controlled by a user. The user may position the top fork 104, 204 (e.g., the first elongated member 104a, 204a and the second elongated member 104b, 204b) about a portion of the instrument 250 and lower the grapple device 100, 200 until the top fork 104, 204 contacts the instrument 250 just above the instrument's boss 252 (e.g., above the top edge 252a of the boss 252). As the top fork 104, 204 contacts the instrument 250, gravity may cause the bottom fork 106, 206 to swing into place under the boss 252 (e.g., below the bottom edge 252b of the boss 252) on the instrument 250. With the instrument 250 positioned between the first elongated member 104a, 204a and the second elongated member 104b, 204b of the top fork 104, 204 and between the first elongated member 106a, 206a and the second elongated member 106b, 206b of the bottom fork 106, 206, the cylinder 118, 218 can be stroked to move the locking pin 116, 216 on the end of the cylinder rod 120, 220 of the cylinder 118, 218 from the first position to the second position and into and/or through the aperture 114, 214 in the locking pin alignment plate 112, 212. The user may visually verify that the locking pin 116, 216 extends through the aperture 114, 214 in the locking pin alignment plate 112, 212. The rope may then be lifted to raise the grapple device 100, 200 and instrument 250 to desired elevation.

The grapple device 100, 200 may provide a positive capture of the instrument 250 (e.g., once the grapple device 100, 200 is engaged with the instrument 250 and the locking pin 116, 216 is extended through the aperture 114, 214 of the locking pin alignment plate 112, 212, the grapple device 100, 200 is not reliant on air or fluid pressure to the cylinder 118, 218 to hold the instrument 250). The grapple device 100, 200 is specially designed for easy installation. The forks 104, 106 and 204, 206 of the grapple device 100, 200 may make it easy to guide the grapple device 100, 200 over the instrument 250 and capture it. Additionally the designed forward tilt of the grapple device 100, 200, when unloaded, may make it such that when the grapple device 100, 200 slides down the instrument 250 and the top fork 104, 204 contacts the instrument boss 252, the bottom fork 106, 206, due to gravity, moves into position about a lower portion of the instrument below the boss 252.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. An apparatus comprising:
a mounting plate;
a fork coupled to the mounting plate, the fork comprising a first elongated member and a second elongated member;
a lifting member coupled to the mounting plate; and
a lifting ring movably engaged with the lifting member.

2. The apparatus of claim 1, further comprising a second fork coupled to the mounting plate, the second fork comprising a third elongated member and a fourth elongated member.

3. The apparatus of claim 2, wherein the mounting plate comprises a top end and an opposing bottom end, wherein the fork is coupled to the mounting plate adjacent the top end of the mounting plate and the second fork is coupled to the mounting plate adjacent to the bottom end of the mounting plate.

4. The apparatus of claim 2, further comprising:
a fifth elongated member having a first end coupled to the first elongated member and a second end coupled to the third elongated member; and
a sixth elongated member having a first end coupled to the second elongated member and a second end coupled to the fourth elongated member.

5. The apparatus of claim 1, wherein the first elongated member is longer than the second elongated member.

6. The apparatus of claim 1, wherein the first elongated member comprises a fixed end and a distal free end, wherein the free end comprises an inwardly curved end member.

7. The apparatus of claim 1, further comprising:
a plate member coupled to the mounting plate and comprising an aperture through at least a portion of the plate member;
a cylinder comprising a cylinder rod configured to move from a first position to a second position; and
a locking pin coupled to a free end of the cylinder rod, wherein the locking pin is configured to engage the aperture in the plate member when the cylinder rod is in the second position and configured to disengage from the aperture when the cylinder rod is in the first position.

8. The apparatus of claim 1, wherein the lifting member comprises a lifting rod, the lifting rod comprising a first end disposed adjacent a top end of the mounting plate and a distal second end disposed adjacent a bottom end of the mounting plate, wherein the lifting rod extends curvilinearly from the first end to the second end, and wherein the lifting ring is disposed about at least a portion of the lifting rod.

9. The apparatus of claim 1, wherein the lifting member comprise a plate member and a curvilinear slot disposed through the plate member, wherein the lifting ring extends into the slot and is movable along the slot.

10. An apparatus comprising:
a mounting plate comprising a top end and an opposing bottom end;
a first fork coupled adjacent the top end of the mounting plate; and
a second fork coupled to the mounting plate.

11. The apparatus of claim 10, further comprising:
a lifting member coupled to the mounting plate; and
a lifting ring movably engaged with the lifting member.

12. The apparatus of claim 10, further comprising:
a plate member coupled to the mounting plate and disposed between the first fork and the second fork, the plate member comprising an aperture extending through at least a portion of the plate member;
a cylinder comprising a cylinder rod configured to move from a first position to a second position; and
a locking pin coupled to a free end of the cylinder rod, wherein the locking pin is configured to engage the aperture in the plate member when the cylinder rod is in the second position and configured to disengage from the aperture when the cylinder rod is in the first position.

13. The apparatus of claim 10, wherein the first fork comprises a first elongated member and a second elongated member and wherein the second fork comprises a third elongated member and a fourth elongated member, wherein the first elongated member is longer than the second elongated member.

14. The apparatus of claim 13, wherein the first elongated member comprises a fixed end and a distal free end, wherein the free end comprises a hook-shaped end member.

15. The apparatus of claim 10, wherein the second fork is coupled to the mounting plate adjacent a bottom end of the mounting plate.

16. The apparatus of claim 10, wherein the first fork comprises a first elongated member and a second elongated member and wherein the second fork comprises a third elongated member and a fourth elongated member, the apparatus further comprising:
a fifth elongated member having a first end coupled to a free end of the first elongated member and a second end coupled to a free end of the third elongated member; and
a sixth elongated member having a first end coupled to a free end of the second elongated member and a second end coupled to a free end of the fourth elongated member.

17. An apparatus comprising:
a mounting plate;
a fork coupled to the mounting plate, the fork comprising a first elongated member and a second elongated member;
a plate member coupled to the mounting plate and comprising an aperture through at least a portion of the plate member;
a cylinder comprising a cylinder rod configured to move from a first position to a second position; and
a locking pin coupled to a free end of the cylinder rod, wherein the locking pin is configured to engage the aperture in the plate member when the cylinder rod is in the second position and configured to disengage from the aperture when the cylinder rod is in the first position.

18. The apparatus of claim 17, further comprising:
a lifting member coupled to the mounting plate; and
a lifting ring movably engaged with the lifting member.

19. The apparatus of claim 17, further comprising:
a second fork coupled to the mounting plate and comprising a third elongated member and a fourth elongated member,
wherein the first fork is coupled to the mounting plate adjacent atop end of the mounting plate and wherein the second fork is coupled to the mounting plate adjacent a bottom end of the mounting plate.

20. The apparatus of claim 19, further comprising:
a fifth elongated member having a first end coupled to a free end of the first elongated member and a second end coupled to a free end of the third elongated member; and
a sixth elongated member having a first end coupled to a free end of the second elongated member and a second end coupled to a free end of the fourth elongated member.
